(19) United States
(12) Patent Application Publication
(10) Pub. No.: US 2021/0140815 A1
(43) Pub. Date: May 13, 2021

(54) SYSTEM AND METHOD FOR SENSING VIBRATIONS IN EQUIPMENT

(71) Applicant: Future Technologies in Sport, Inc., North Andover, MA (US)

(72) Inventors: Jacob Van Reenen Pretorius, Austin, TX (US); James Fry, North Andover, MA (US); Eric Oleg Bodnar, Santa Cruz, CA (US)

(21) Appl. No.: 17/262,693

(22) PCT Filed: Jul. 23, 2019
(86) PCT No.: PCT/US19/43128

§ 371 Date: Jan. 22, 2021

Related U.S. Application Data
(60) Provisional application No. 62/702,329, filed on Jul. 23, 2018.

(51) Int. Cl. G01H 11/08; G01P 15/09

(52) U.S. Cl. CPC G01H 11/08; G01P 15/09

(57) ABSTRACT

This invention provides a low-profile, highly-sensitive, high-frequency sensor that can be affixed to equipment. Low-profile electronics with the ability to capture and analyze specific signals of concern can be utilized as to remain unobtrusive. Vibration data can be captured and stored locally on the equipment where user-defined code can analyze data and pick specific parameters of concern to send via the wireless communications link to a receiver. The receiver is able to capture the data and monitor parameters of the equipment.

### FIELD OF THE INVENTION

This invention relates to manufacturing and applying high-frequency vibration sensors to industrial equipment, electronics to interpret vibrations, software to identify information regarding vibration and methods to communicate vibration related information to devices physically removed from the equipment.

### BACKGROUND OF THE INVENTION

The Internet-of-Things (IoT) age of micro-electronic devices, connected servers, large-cloud-based storage and fast acting machine learning algorithms rely on large arrays of distributed sensors. In the fields of structural health monitoring and predictive maintenance there is a need for great number of sensors to be distributed over all areas of the plant often in remote or hard to reach areas in order to continuously and in real-time monitor the health of machinery, equipment and other infrastructure.

The field of structural health monitoring is well-established with many products and solutions being offered to continuously monitor the physical properties of aerospace, civil and mechanical engineering structures, plants and equipment. Well-known protocols to react to changes in the physical properties of the plant exist and are implemented to avoid downtime, interruption of service or even failures.

In the field of predictive maintenance it is desired to have continuous access to remote data which represents the current state of a plant or a component of the plant. Based on this state and previous learnings, certain futuristic properties of the plant can be predicted. Maintenance crews can therefore be alerted to potential failures or anomalies and can rectify the situation well in advance of any adverse events taking place. This timely intervention can prevent downtime, lost productivity and costly emergency rectification.

In the field of sports it is desired to track and monitor the key performance indicators for racket, bat, helmet, ball and players as well as other sports involving the interaction of apparel, shoes and equipment. Real-time data about player and equipment performance can provide interesting and unique insights to coaches, players, broadcasters and fans. This data can be delivered instantly to end-users and its machine learning algorithms via the intelligent edge, the intelligent cloud and mobile and other devices allowing for enjoyment, intervention and analysis.

Sensors are the most effective when they don't influence the measurement. For instance, as is well known by those skilled in the art, when mechanical vibrations of a system needs to be monitored, any measurement equipment that is attached to the system will change the mass or inertia of the system and thereby influence and alter the natural vibration frequencies of the system. Thus, by trying to measure the natural frequencies of the system, the actual frequencies are altered, resulting in erroneous measurements being made. Indirect measurement techniques are non-intrusive but lack the detail information that can only be gathered by physical contact with the system. It is therefore desired to have a manner to place measuring equipment on systems that will have a minimal effect on the mass and inertia of the system.

To date, sensor packages in the prior art resided in enclosures that protect the sensors from external factors such as impact, weather including temperature, humidity and moisture, dust, chemicals and other substances that can cause harm to the sensors and their associated electronics. These sensors have been bulky, heavy, of substantial thickness, intrusive, power hungry, and expensive. These sensors with bulky, heavy, and thick enclosures increase the performance required by the mechanism adhering the sensor system to the device being sensed. This performance increase is driven by the fact that heavier equipment experiences larger forces for the same acceleration, bulky devices tend not to conform to surfaces and thick enclosures increase the inertia of the system, causing edges to experience substantially larger forces and peel during movement and accelerations. These factors combine to place significant stress on the adherence mechanism employed to attach the sensor system to the host, often requiring intrusive methods such as one or more screws, hard-and/or slow-curing epoxies and snap on systems that have to be designed into the host system. Furthermore, attaching these sensors to the plant, equipment, machinery or infrastructure involves labor intensive and intrusive practices in order to ensure proper measurement and robustness and requires substantial human intervention. Often the original equipment manufacturers have a clause in its warranty agreement that voids said warranty in case of modification such as drilling into said equipment. In many cases these clauses exclude the addition of branding and other external markings. Intrusive attachment of third party devices can potentially negate the original equipment manufacturer's warranty of said equipment. It is therefore desirable to provide end users with a small sensor that has an easy to apply bonding method that does not require invasion or alteration of the host and/or preserve the warrantee of the system being sensed.

### SUMMARY OF THE INVENTION

The invention described here overcomes these deficiencies of the prior art by providing a non-obtrusive, properly connected, easily attached sensor that can measure, record, manipulate, construct and transmit several types of measurements, active and passive, and data including high speed vibration, dynamic strain, static strain, three-axis acceleration, three-axis rate of rotation, temperature, pressure, humidity, location, air-quality, and/or any other type of data that can be measured with sensors that will fit within the specified package of the system. The sensor system can collect and interpret data, correlate data with events, perform machine learning functions and thus provide useful information to the end user.

It is an object of the invention to provide a sensor package that has a low profile so that movement and acceleration do not cause substantial inertial forces on the adherence method. Furthermore, it is an objective of the invention to describe a sensor package that is hermetically sealed against the environment so that a bulky enclosure that increases stresses on the adherence method is not required. It is also an objective of the invention to describe a sensor package that can conform to the structure of the host device, thereby proving ample surface area for adherence.

One attribute of the sensor is its form factor. The sensor can be less than 2 mm thick with a density of less than 3.5 kg/m². This form factor allows it to have several beneficial features. The low area mass density of the system allows it to be soundly adhered to structures and equipment with double sided tape, even in high acceleration environments. The thin nature of the system can negate inertial moments on the adhesive, increasing reliability. Due to the thin nature and physical flexibility of the materials used in its construction, the sensor can conform to common engineering and product shapes and forms. The above features can combine to make the sensor non-obtrusive. The low mass and area mass density of the system severely restricts its influence on the natural frequencies of vibration of the structure it is adhered to, increasing measurement accuracy.

In an illustrative embodiment, a system for measuring and reporting vibrations can include at least one sensor, at least one transmitting antenna, a central processing unit, a battery, and a package that encapsulates the system, wherein the overall thickness of the package is approximately 2 mm or less. The system can have an inductive wireless charging coil. The system can have at least one sensor that can be a vibration sensor, a dynamic strain sensor, or a vibration and dynamic strain sensor. The vibration and/or dynamic strain sensor can be a piezo ceramic. The vibration and/or dynamic strain sensor can be a piezo polymer. The system can include an inertial sensor. The system can include a static strain sensor. The system can have a mass density of approximately 3.5 kg/m² or less. The system the system can be adhered to a structure with an adhesive with a peel strength of approximately 550 Pa or more and adhesive strength of approximately 2.2 kPa or more. The adhesive can be a double sided tape. The package can be constructed with flexible polymer materials that allow the system to conform to engineering surfaces. The system can conform to a radius of approximately ¾ or less. The outer encapsulation can allow for the addition of printed logo and branding. The branding or logo can allows for the system under the branding or logo to be hidden from the user. The central processing unit can perform analog-to-digital signal conversion. The processing unit is capable of digital signal filtering. The processing unit is capable of packaging and delivering wireless signals to another device. The processing unit is capable of receiving firmware-over-the-air updates.

In an illustrative embodiment, a system for measuring and reporting vibrations can include at least one sensor, at least one transmitting antenna, an inductive wireless charging coil, a central processing unit capable of digital signal processing, a battery, and a package that encapsulates the system, wherein the data from the at least one sensor can be transmitted to the cloud via an edge device where computational methods can be performed on the data to provide actionable results.

In an illustrative embodiment, a method for measuring and reporting vibrations can include obtaining a bat having a system for measuring and reporting vibrations, the system for measuring and reporting vibrations including at least one sensor, at least one transmitting antenna, a central processing unit, a battery, and a package encapsulating the system, wherein the overall thickness of the package is approximately 2 mm or less, swinging the bat at a ball, impacting the ball with the bat, and causing a signal to be sent from the bat to a receiver indicating that an impact occurred.

### BRIEF DESCRIPTION OF THE DRAWINGS

The invention description below refers to the accompanying drawings, of which:

FIG. 1 is an exploded view of the sensor, according to an illustrative embodiment;

FIG. 2 is a cross sectional view of the sensor taken along cross section line 2-2 of FIG. 1, illustrating the packaging of the sensor, according to an illustrative embodiment;

FIG. 3 is a schematic diagram showing the interaction of the sensor with the relevant devices and users of the invention, according to an illustrative embodiment; and

FIG. 4 is a schematic diagram showing the conformity of the system to concave and convex surfaces, according to an illustrative embodiment.

### DETAILED DESCRIPTION

The invention described here combines multiple sensors in a small, unobtrusive and slight form factor package that is easily and non-intrusively applied to functional structures in order to sense, record, capture and transmit information of said structures to edge devices, control systems, databases, machine learning algorithms and other processes and functions that can benefit from said information.

Objects of the invention include is its multi-functionality, its low profile and its ease of application and use. These factors combine to create a novel, rapidly deployable, ubiquitous sensor system and/or network that has utility in the fields of sports, medicine, defense, oil-and-gas, aerospace, automotive, industrial processes, maintenance, health-monitoring, controls and many more.

FIG. 1 is an exploded view of the sensor, according to an illustrative embodiment. The sensor system 100 can be entirely encapsulated between top layer 102 and bottom layer 104. Top layer 102 and bottom layer 104 can be constructed from many materials that will resist environmental, chemical, thermal and other external factors that might cause damage to the sensor package. These materials can include polyamide, PET, FR4 and other materials known to those skilled in the art to resist external harmful factors. Top layer 102 and bottom layer 104 can also be made from flexible materials that elastically strain without large stresses in order for the entire package to be flexible as is known in the art. Alternatively layers 102 and 104 can be made from harder materials such as metals or fiber reinforced materials in order to resist impacts from objects and generally improve the protection of the sensor package. Top layer 102 can serve as a vanity sticker that can incorporate branding and logos for the package or the device that the package is adhered to. Furthermore, top layer 102 can also include charging coil 118 or other electronics on the inner side of top layer 102. The durable material of top layer 102 can be folded over the package to also form the bottom layer and encapsulate the entire package.

Bottom layer 104 can incorporate exterior adhesive 106. Exterior adhesive 106 can be a double sided tape. There are numerous of these types of tape available from manufacturers like 3M and Scotch with various thicknesses, adhesions, environment properties, etc. available. The double sided tape can be selected based on the specific application of sensor package by optimizing the options to best suit the application as will be known to those skilled in the art. For instance, 3M VHB 9474LE, 9495LE, 9629PC or any other suitable adhesive can be selected for the application of the package to cricket bats where the thin nature and specific application to wood and plastics are ideal to ensure adherence during use over a wide temperature range as well as proper transfer of vibration and strain signals to the vibration, dynamic strain, and static strain sensors. The adhesive strength of the adhesive can be less than 600 Pa, 400-500 Pa, 500-600 Pa, 600-800 Pa, 400-1,000 Pa, 400-2,000 Pa, 300-3,000 Pa or 1,000-10,000 Pa. The peel strength of the adhesive can be in a range from 10-40 N/25 mm. The peel strength of the adhesive can be more than 10 N/25 mm. The peel strength of the adhesive can be in a range from 1-20N/25 mm.

The sensor package can have many sensors that can be configured to provide the user with the desired information. Vibration and/or dynamic strain sensor 108 can be a piezoelectric sensor that generates charge in response to strain as known by those skilled in the art. This charge can be fed into a charge amplifier that reduces the charge into voltage that can be transformed for data acquisition by an analog to digital converter as known to those skilled in the art. Vibration and/or dynamic strain sensor 108 can be a piezo ceramic of type PZT-5A, PZT 5H or any ceramic known to those skilled in the art. If the sensor package is required to be flexible, vibration and/or dynamic strain sensor 108 can be a piezo polymer such as PVDF and can be an off the shelf sensor such as MEAS DT series such as the DT1-028K or any other vibration sensor as will be known to those skilled in the art. Vibration and/or dynamic strain sensor 108 can be bonded to bottom layer 12 in order to ensure maximum strain transfer from the device under measurement. This bonding can be via double sided tape, epoxy, B-stage epoxy or any other type of bonding that will be known to those skilled in the art. Vibration and/or dynamic strain sensor 108 can also be directly added to functional layer 110 as will be known to those skilled in the art. Functional layer 110 can include various electronics, explained more fully below.

The sensor package can be configured to carry multiple vibration and/or dynamic strain sensors 108 that can be bonded to bottom layer 104 and/or it can incorporate a strain gauge or multiple strain gauges if the user wants to obtain static strain measurements. These stain gauges can be purchased off the shelf or can be directly etched into bottom layer 104 by methods known by those skilled in the art. If a copper-kapton substrate is used for etching a strain gauge, the strain gauge can mimic that of a traditional copper type gauge in the sense that it will have to be a long, thin strip of copper in order to increase the resistance of the gauge as is known to those skilled in the art. Typically this is achieved by making a thin zig-zag pattern of copper. These type of gauges are susceptible to breakage since the copper is so thin. However, etching the gauge directly into the substrate can give it more strength and can ease the connection of electrodes to the gauge. Alternatively, a high resistance substrate such as that used in DUPONT™ KAPTON® 200RS100 can be used. In this case the material has high enough internal resistance so that the gauge strip can be thicker, more robust, shorter and easier to connect to. As will be known to those skilled in the art, regardless of the method of making the gauge, multiple gauges can be etched together to form a rose so that a Wheatstone bridge can be used for accurate point strain measurements as is known to those skilled in the art. Furthermore, multiple rose configurations can be etched next to each other in order to get multiple, accurate strain measurements.

The functional layer 110 of the sensor package can have multiple electronic functions. It can house the conductive paths that connect vibration sensor(s), dynamic strain sensor(s), or vibration and dynamic strain sensor(s) 108, flat battery 112, primary RF antenna 114 (e.g. Bluetooth), secondary RF antenna 116 (e.g. near-field), inductive charging coil 118, inertial sensors 120, factory programming and test connector 122, and/or Central Processing Unit (CPU) 124 to all the electronic components consisting of resistors, capacitors and charge amplifiers.

Sensor system 100 can have a mass density of 3 kg/m²or less. Sensor system 100 can have a mass density of 3.5 kg/m²or less. Sensor system 100 can have a mass density of 4 kg/m²or less. Sensor system 100 can have a mass density of 5 kg/m²or less. Sensor system 100 can have a mass density in a range from 1 to 3.5 kg/m². Sensor system 100 can have a mass density in a range from 1 to 5 kg/m².

One attribute of the low profile of the package is flat battery 112. This battery can have a thickness of 1 mm to 0.1 mm and can provide power to the entire package. The battery can be bonded to functional layer 110 via methods known to those skilled in the art such that the large area of bonding combined with the bonding strength of the adhesive and the relatively low area mass density of the battery allows the battery to stay attached during periods of high acceleration. In various embodiments the sensor can be free of a battery and/or can have power provided through cords, solar cells, capacitors, or other means.

Charging coil 118 is a wireless charging receptacle that can be utilized with most off-the-shelf wireless charging devices found on the market and known to those skilled in the art. Charging coil 118 can consist of a number of etched rings that provide a coil sufficient to receive electromagnetic power from a wireless charging system. Charging coil can receive electromagnetic energy and convert it to alternating current (AC) electricity. This electricity can then be converted by the electronics to direct current (DC) and utilized to directly power the device and/or charge the battery or capacitor, if a battery and/or capacitor are included and need charged, in a manner that is well known to those skilled in the art.

Inertial sensors 120 can provide 3 axis acceleration and 3 axis gyroscopic rotation data. These sensors are commonly used in applications to determine the acceleration and rotational speed of objects and translate those measurements into displacement, speed and orientation of the object as is well known to those skilled in the art. Inertial sensors 120 can also include magnetic and or magnetic flux measurement sensors in order to sense the orientation of the sensor package with regard to the earth's magnetic field.

CPU 124 can be at the heart of the package. CPU 124 can be an Integrated Circuit (IC), ARM Cortex M4F or any similar device and performs several functions know to those skilled in the art. These can include collecting data from sensors, including converting analog sensor signals into digital format; storing data from sensors in local memory and buffers; performing mathematical functions such as signal analysis on data collected; reacting and performing functions based on inputs including data from sensors; executing control algorithms; decimating data to reduce its size, packaging data for transfer; initiating data transfer; performing, initiating and managing wireless data transfer including Bluetooth; managing battery power; allowing batteries to be charged and controlling the process of being charged; adding a time stamp to the data; and/or being programmed via programming connector 122 or via firmware over the air (FOTA), and many more as will be appreciated by those skilled in the art.

CPU 124 can have multiple analog-to-digital and digital input ports to collect data from multiple sensors providing data in analog or digital format. The package described in this invention can collect data from vibration sensors, dynamic strain sensors, accelerometers, strain gauges, gyroscopes, magnetic sensors, temperature sensors, pressure sensors, humidity, location, air quality, as well as other sensors that can be added to the package as desired. CPU 124 can have digital and/or analog output ports to perform control functions such as turning switches on and off, increasing or decreasing speed of equipment, proportionally adjusting power to equipment, alert users to systems states and other control functions as will be known to those skilled in the art.

CPU 124 can be programmed to lie dormant and utilize minimum energy until a predetermined threshold on one of the sensors is exceeded. At this time it can wake up and collect data selectively from the several sensors that it is connected to. Furthermore CPU 124 can collect data in its buffers before the threshold is reached in order to obtain pre-threshold data. CPU 124 can also collect data at different speeds from, for example, approximately 0.001 Hz to approximately 250 kHz or more from different sensors including taking data of any sensor at a minimum rate of, for example, approximately 10 kHz.

CPU 124 can be programmed to perform signal analysis and digital signal processing on data such a high-pass filtering, low pass filtering and band-pass filtering. It can also perform frequency functions such as Fourier transforms and calculate signal related information such as damping ratios, phase lag, modal identification such as bending and torsional modes, power transfer coefficients and other signal-related calculations known to those skilled in the art. It can use these calculations to inform on the structure that the package is connected to including calculating the relative and/or absolute position of impacts on the structure. CPU 124 can then package this data for transfer to other devices.

CPU 124 can also be programmed to interpret 3-axis gyroscope and 3-axis accelerometer data, integrate and transform this data to provide speed, displacement and orientation of the sensor over the period that the data was collected. The mathematics and sequence of calculations involved in transforming the data is well known to those skilled in the art.

CPU 124 can selectively package data in a format for transfer via Bluetooth low energy (BLE) via Bluetooth antenna 114. For instance it can decide to send time sensitive information in a small package to be delivered first and then send less time sensitive data at a later stage, taking longer for more data and data packages to be delivered. In various embodiments, time sensitive data can include information regarding the health of machinery and the need to shut them down due to imminent failure of the machine. These machines might include turbines, pumps, fans and other motor driven equipment or equipment that incorporate bearings. Time sensitive data can include information about sports equipment that can be overlaid in for real time viewing on live television for enhanced audience engagement. Time sensitive data can include information on structures such as aircraft wings, truss structures, bridges and the like that are about to fail to ensure timely execution of mitigation procedures. Time sensitive data can include manufacturing quality control data to enable adjustment of parameters to restore yield of production equipment.

Similarly, CPU 124 can select another wireless means of data transfer via wireless antenna 116. These modes of data transfer such as Wi-fi, LAN, WALAN, LTE Bluetooth, Cellular, Zigbee, WiGig, Z-Wave, and others as are known to those skilled in the art that can potentially be faster, more reliable and transfer more data in a shorter period of time over a longer distances than BLE. CPU 124 can be programmed by the user to select the desired mode or modes of wireless data transfer.

It is an object of the invention to provide a low profile for the sensor package. Where FIG. 1 illustrated the expanded sensor package in order to identify the individual layers, FIG. 2 presents a bonded, integrated package that is ready to be adhered to a structure. FIG. 2 is a cross sectional view of the sensor taken along cross section line 2-2 of FIG. 1, illustrating the packaging of the sensor, according to an illustrative embodiment. Layers can be integrated in a manner that minimizes the overall thickness of the sensor package, providing substantial improvement over the prior art. The present invention provides a sensor package that has a low profile so that movement and acceleration do not cause significant inertial forces on the adherence method. The sensor package can be hermetically sealed against the environment so that a bulky enclosure that increases stresses on the adherence method is not required. The sensor package can conform to the structure of the host device, thereby proving ample surface area for adherence.

FIG. 4 illustrates the conformability of sensor system 100. Sensor system 100 can conform to engineering surfaces that can be convex or concave surfaces, including surfaces with both concave and convex areas. Sensor system 100 can be adhered to an object or structure 400, including a concave surface 402 and a convex surface 404 of object 400. Sensor system 100 can be adhered to a concave surface 402 that can have a radius R1 that can be in the range of ¼: to ¾″, ½″ to ¾″. ¼ to 1″, less than ¾″, ¼″ to 4″, ¼″ to 20″ and ¼″ to infinite. i.e a flat surface. Radius R1 can be approximately ¾″ or less. Sensor system 100 can be adhered to a convex surface 404 can have a radius R2 that can be in the range of ¼″: to ¾″, ½″ to ¾″. to 1″, less than ¾″, ¼″ to 4″, ¼″ to 20″ and ¼″ to infinite. i.e a flat surface. Radius R2 can be approximately ¾″ or less.

FIG. 2 illustrates one embodiment of the layers of the invention such that that the overall thickness of the sensor package can be approximately 2 mm or less. The overall thickness of the sensor package can be approximately 1.5 mm or less. The overall thickness of the sensor package can be approximately 1 mm or less. Exterior adhesive layer 106 can be a double sided tape of thickness approximately less than 0.2 mm. One side of the double sided adhesive can be attached to bottom layer 104. Bottom layer 104 can be attached to lower encapsulant layer 202 that can adhere vibration and/or dynamic strain sensor 108 and functional layer 110 to bottom layer 104. Lower encapsulant layer 202 can also be known as lower adhesive layer 202. Functional layer 110 can contain CPU 124 and other electronics that can be adhered to it utilizing soldering techniques such as reflow soldering know to those skilled in the art. Flat battery 112 can also be bonded to functional layer 110 via a battery adhesive 204. Functional layer 110 can also be bonded to wireless antenna 116 and charging coil 118 via middle adhesive layer 206 which in turn can be bonded to top layer 11 via top adhesive layer 208. Middle adhesive layer 206 and top adhesive layer 208 can also be known as middle encapulant layer 206 and top encapsulent layer 208, respectively. The process of integrating the different layers is well known to those skilled in the art. Encapsulant layers 202, 206, and 208 as well as battery adhesive 204 can be any of a number of encapsulants and/or adhesives known to those skilled in the art such as thermoset or thermoplastic resins, epoxy, silicon, tape adhesive or any other adhesive that can serve to encapsulate and bond materials together and protect layers from the environment as is well known to those skilled in the art. All encapsulants and adhesives utilized to bond the components of the sensor system together can be of such thickness that the overall thickness OT of the system can be less than approximately 1 mm, less than approximately 1.5 mm, or less than approximately 2 mm in order to obtain the benefits describes above.

FIG. 3 is a schematic diagram showing the interaction of the sensor with the relevant devices and users of the invention. FIG. 3 illustrates how the flexibility of the sensor system can be utilized to provide useful and actionable information to the user. Sensor 100 can be structurally connected to equipment 302 via double sided adhesive 204 or other means as known to those skilled in the art thereby able to sense relevant physical information from the system. Equipment 302 can be industrial manufacturing equipment, sporting equipment, motorsports equipment, or any other equipment that can benefit from the monitoring described herein. Sensor 100 can sense and interpret data according to a current firmware package that can be running on CPU 124 This firmware can be altered and updated as described below. The amount of data collected from which sensor at which rate can be determined by the firmware. The firmware can collect, store and/or manipulate the information from the sensors. The algorithms in the firmware can decide what information to broadcast, when to broadcast and/or in which format to broadcast the information. Broadcasting the information can be via at least one of the multiple wireless data transmitting methods enabled by the sensor 100 and described above. Sensor wireless transmission 306 can be received by edge device 308 via radio receiver 310 or received by wireless device 312 via inbuilt antenna. Wireless device 312 can include smart phones, tablets, computers and any device capable of receiving wireless data, displaying information on a screen and accepting inputs from a user 314. Transmitted data can be encrypted with a deciphering key located on the wireless device 312 or edge device 308. Sensor-to-edge device data 316 can be transmitted from the sensor 100 to the edge device 308, and edge device-to-sensor data 318 can be transmitted from the edge device 308 to the sensor 100. Sensor-to-edge data 316 can include the information that the sensor's firmware has packaged and sent to edge device 308. Edge device 308 can also be capable of receiving information from multiple sensors 100. Edge device 308 can receive data, can decipher it, and/or can perform further manipulation of the data as defined by its firmware or software. Edge-to-cloud data 322 can be transmitted from the edge device 308 to a cloud 320, and cloud-to-edge device data 324 can be transmitted from the cloud to the edge device. Edge device 308 can upload data to cloud 320 via edge-to-cloud upload 322, or edge device 308 can transmit data via a connection that can be a secured wired transmission 326 to hub 328 where it can be distributed to user station 330 and user 331 via hub-to-station data transmission 329, and/or uploaded to cloud 320 via a connection that can be a wired hub-to-cloud uplink 332. Wireless device 312 can receive data from sensor 100, that can be manipulated, displayed to user 106, manipulated by user 106, stored, and transmitted by the wireless device 312. Handheld device 312 can receive sensor-to-device data 334 from the sensor 100. Sensor-to-device data 334 can be in different formats depending on the type of handheld device 312 where handheld device 312 can identify to sensor 100 in what format it would prefer sensor-to-device data 334. Handheld device 312 can transmit device-to-cloud data 338 to cloud 320 and can receive cloud-to-device data 340 from the cloud 320 via the many wireless formats known to those skilled in the art. Cloud- to-device data 340 can be in different formats depending on the type of handheld device 312 where handheld device 312 can identify to sensor 320 in what format it would prefer cloud-to-device data 340.

Regardless of the route, data can be stored on the cloud where it can be further manipulated, analyzed, massaged and/or made available for users. For example, cloud 320 can transmit or upload data to an analyst station 342 where an analyst 344 can perform sophisticated simulations, statistical analysis, correlation with other data and observations, machine learning, and/or other artificial intelligence interpretation activities know to those skilled in the art. These kind of activities often take significant computation resources and in some cases cannot be done in real time. Instead the analysis and correlation of the data can be performed in an “offline” state where time critical decisions are not required. “Offline” data interpretation can find correlation between data collected by sensor 100 and performance characteristics of equipment 302. Once actionable parameters collected by sensor 100 are identified and the relevant algorithms to interpret parameters and correlate behavior of equipment 302 have been developed, tested and verified in the “offline” state, these algorithms can be packaged and compiled in a firmware upgrade that can enable sensor 100 to notify users via edge device 308 or handheld device 312 of measured characteristics of equipment 302 in real time via its “online” firmware.

The flexibility of the invention can be illustrated by the following illustrative example. When analyst 344 wants to update the firmware of sensor 100, the update can be transmitted to cloud 320 with instructions of what sensors need to be updated. This information can be collected by cloud 320 via analyst-to-cloud interface 346 and 348. Cloud 320 can have the ability to transmit updated firmware to the relevant sensor 100 via a number of options. For instance, it can use cloud-to-wireless device interface 340 to send updated firmware to wireless device 312. Here user 314 can decide to upload firmware to sensor 100 or algorithms of the wireless device 312 can decide when to upload new firmware to sensor 100. Alternatively cloud 320 can use hub 328 to securely transmit firmware via hub-to-cloud interface 322, and from there it can be transmitted to edge device 308 via hub-to-edge interface 326. Furthermore, firmware can also be directly transmitted from cloud 320 to edge device 308 via cloud-to-edge interface 324. Whatever the route, edge device 308 can update the firmware of sensor 100 via edge-to-sensor interface 318. Identification, additional firmware upgrades, and other maintenance related uploads can be delivered from cloud 320 to sensor 100 by any or all of the routes described above.

Additionally, analyst 344, or any other user with access to cloud 320, can decide to update software and or firmware of edge device 308 or wireless device 312, and can utilize any of the many pathways for data and code transfer as described above. These illustrative examples are intended to illustrate the flexibility of the various components of the system to be updated in real time as users and analysts choose, without (free of) physically being in contact with sensor 101, edge device 308 or wireless device 312. Such methods of firmware over the air (FOTA) are well known to those skilled in the art.

The system of transmitting updates, maintenance and other housekeeping related uploads to and from sensors and interfacing devices serves to illustrate the multi-functionality and the ability of the system to evolve with time. As with any Internet-of-things (IoT) system, knowledge and functionality keeps improving as more devices (such as wireless device 312 and cloud 320) as well as sensors 100 are distributed to multiple pieces of equipment 302, and as data from sensors 100 and other sensors and information are correlated to behaviors. Those skilled in the art refer to the gaining of this knowledge and the ability to train machines to recognize behavior as machine learning. The examples above illustrate how the multi-functionality of the system described in this patent allows high-fidelity simulations, statistical correlations and other artificial intelligence functions to be performed “offline,” including by analysts 344 on analysts stations 342. As these learnings are transferred into actionable code, these can be seamlessly uploaded to sensors 100 and devices 312 and 308 for operation “online”. Typically these “online” functions can be reduced order models and code that are simpler to run and faster to execute on the more simplistic, less-powerful and memory starved processors , such as CPU 124, that can be deployed by sensor 100 and edge device 308 or wireless device 312.

“Online” operations can involve monitoring and sensing behavior of equipment 302 by sensor 101. When attributes of equipment 302 are sensed by sensor 100, sensor 100 will be able to take certain actions in response to the state of the sensed attributes. As a non-limiting example, when certain frequencies are generated by rotating machine bearings, it might indicate that the bearings have worn and will need replacement. Other, more critical attributes might be identified as having safety and security risks and thus might warrant prompt or immediate shutdown or interruption, or other control related activity of equipment 302. The system of communication between sensor 100 and edge device 308 and/or wireless device 312 will enable the communication of these sensed attributes to the relevant control authority. This control authority might be user 314 or it can be a control system coupled to cloud 320 that can be instructed via the communications pathways described here about the state of the equipment. The control system(s) of the equipment can then execute the relative reactions in response to the state of the equipment as sensed and interpreted by the system described here.

In various embodiments, sensor 100 data can be used for functions other than controls. For example, in sports, the performance of a player can be monitored in real time by analyzing his or her equipment. This information can then be transmitted to broadcasters for displaying performance related information on television broadcasts, for instance. The information can also be sent to users' wireless devices directly. The information can be correlated with other game statistics and match related information. This in turn can help analysts, broadcasters, coaches, players and fans to improve their respective performances. The sensor can report the occurrence of an impact between two objects such as a bat and a ball. The sensor can report the non-occurrence of an impact between two objects such as a bat and a ball. It is an object of the invention to provide a system that can rapidly gather data from sports equipment, translate the data into relevant information and rapidly transmit that information to users as to have a minimum delay of the availability of the information. The system can transmit data to users in less than 0.3 seconds, 0.1 to 0.3 seconds, 0.1 to 0.5 seconds and/or 0.1 to 1 second. As a non-limiting example, on sport equipment that impact objects, it is an objective of the invention to deliver information on the speed of the equipment, the occurrence or non-occurrence of an impact, the orientation of the equipment at impact, the amount the equipment moves after impact, the location and/or relative location of the impact, the amount of power available to the object at impact and other relative information related to the impact and its potential result, in less than approximately 0.5 seconds, to cloud 320 from where it can be distributed to users 314 and 331, and analysts 344 almost in real time. In various embodiments a sensor system can provide results that can be actionable. Actionable results can include indication of an impact, indication that a machine needs repairs, indication of future machine performance, indication that a system failure is imminent, or other information that a user should take action.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, locations to which the senor can be applied are highly variable and multiple sensors can be applied at various locations on the equipment and can work in coordination or discretely based upon controlling circuitry that selects and/or combines signals in accordance with skill in the art. Furthermore, while the foregoing describes a number of separate embodiments of the apparatus and method of the present invention, what has been described herein is merely illustrative of the application of the principles of the present invention. It is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A system for measuring and reporting vibrations comprising:
at least one sensor;
at least one transmitting antenna;
a central processing unit;
a battery; and
a package, the package encapsulating the system, wherein the overall thickness of the package is approximately 2 mm or less.

2. The system of claim 1 further comprising an inductive wireless charging coil.

3. The system of claim 1 wherein the at least one sensor includes a dynamic strain sensor.

4. The system of claim 3 wherein the dynamic strain sensor is a piezo ceramic.

5. The system of claim 3 wherein the dynamic strain sensor is a piezo polymer.

6. The system of claim 1 wherein the at least one sensor includes an inertial sensor.

7. The system of claim 1 wherein the at least one sensor includes a strain sensor.

8. The system of claim 2 where the area mass density of the system is approximately 3.5 kg/m² or less.

9. The system of claim 8 wherein the system can be adhered to a structure with an adhesive with a peel strength of approximately 550 Pa or more and adhesive strength of approximately 2.2 kPa or more.

10. The system of claim 9 wherein the adhesive is a double sided tape

11. The system of claim 1 wherein the package is constructed with flexible polymer materials such that the system can conform to engineering surfaces.

12. The system of claim 12 wherein the system can conform to a radius of approximately ¾″ or less.

13. The system of claim 1 wherein the outer encapsulation allows for the addition of printed logo and branding.

14. The system of claim 12 wherein the branding or logo allows for the system under the branding or logo be hidden from the user.

15. The system of claim 1 wherein the central processing unit can perform analog-to-digital signal conversion.

16. The system of claim 1 wherein the processing unit is capable of digital signal filtering.

17. The system of claim 1 wherein the processing unit is capable of packaging and delivering wireless signals to another device.

18. The system of claim 1 wherein the processing unit is capable of receiving firmware-over-the-air updates.

19. A system for measuring and reporting vibrations comprising:
at least one sensor;
at least one transmitting antenna;
an inductive wireless charging coil;
a central processing unit capable of digital signal processing;
a battery; and
a package, the package encapsulating the system;
wherein the data from the at least one sensor is transmitted to the cloud via an edge device, wherein computational methods are capable of being performed on the to data to provide actionable results.

20. A method for measuring and reporting vibrations comprising:
obtaining a bat having a system for measuring and reporting vibrations, the system for measuring and reporting vibrations including at least one sensor, at least one transmitting antenna, a central processing unit, a battery, and a package encapsulating the system, wherein the overall thickness of the package is approximately 2 mm or less;
swinging the bat at a ball;
impacting the ball with the bat; and
causing a signal to be sent from the bat to a receiver indicating that an impact occurred.
